(19) United States
(12) Patent Application Publication
(10) Pub. No.: US 2024/0283590 A1
(43) Pub. Date: Aug. 22, 2024

(54) SEQUENCE GENERATION FOR SMALL RESOURCE BLOCK ALLOCATIONS OF PHYSICAL UPLINK SHARED CHANNEL TRANSMISSIONS

(71) Applicant: QUALCOMM Incorporated, San Diego, CA (US)

(72) Inventors: Gokul SRIDHARAN, Sunnyvale, CA (US); Wei YANG, San Diego, CA (US); Peter GAAL, San Diego, CA (US)

(21) Appl. No.: 18/545,884

(22) Filed: Dec. 19, 2023

Related U.S. Application Data
(60) Provisional application No. 63/485,799, filed on Feb. 17, 2023.

(51) Int. Cl. H04L 5/00; H04W 72/1268

(52) U.S. Cl. CPC H04L 5/0044; H04L 5/0051; H04W 72/1268

(57) ABSTRACT

Methods, systems, and devices for wireless communications are described. For example, a network entity may transmit, and a user equipment (UE) may receive, for generation of a demodulation reference signal sequence corresponding to a resource block allocation, control signaling indicative of a selection of a root number and a prime number. The prime number is one of two or more prime numbers used to generate a set of demodulation reference signal sequences for the resource block allocation. The UE may generate, using the prime number and the root number as input into a sequence generation function, the demodulation reference signal sequence of the set of demodulation reference signal sequences corresponding to the resource block allocation and transmit a physical uplink shared channel transmission including the demodulation reference signal sequence.

### CROSS REFERENCE

The present application for patent claims the benefit of U.S. Provisional Patent Application No. 63/485,799 by SRIDHARAN et al., entitled “SEQUENCE GENERATION FOR SMALL RESOURCE BLOCK ALLOCATIONS OF PHYSICAL UPLINK SHARED CHANNEL TRANSMISSIONS,” filed Feb. 17, 2023, assigned to the assignee hereof, and expressly incorporated by reference herein.

### FIELD OF TECHNOLOGY

The following relates to wireless communications, including sequence generation for small resource block allocations of physical uplink shared channel transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A user equipment (UE) may transmit physical uplink shared channel (PUSCH) transmissions with corresponding demodulation reference signals (DMRSs) that are used for channel estimation and demodulation of PUSCH data at the receiver (e.g., network entity). The UE may generate a DMRS sequence for the DMRS using various techniques, which may depend on the DMRS allocation in the PUSCH and/or the waveform used for the PUSCH transmission.

### SUMMARY

The described techniques relate to improved methods, systems, devices, and apparatuses that support sequence generation for small resource block allocations of physical uplink shared channel transmissions. For example, the described techniques provide for a network entity transmitting and a user equipment (UE) receiving, for generation of a demodulation reference signal sequence corresponding to a resource block allocation, control signaling indicative of a selection of a root number and a prime number. The prime number is one of two or more prime numbers used to generate a set of demodulation reference signal sequences for the resource block allocation. The UE may generate, using the prime number and the root number as input into a sequence generation function, the demodulation reference signal sequence of the set of demodulation reference signal sequences corresponding to the resource block allocation and transmit a physical uplink shared channel transmission including the demodulation reference signal sequence.

A method for wireless communications by a user equipment (UE) is described. The method may include receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation, generating, using the prime number and the root number as input into a sequence generation function, the demodulation reference signal sequence of the set of demodulation reference signal sequences corresponding to the resource block allocation, and transmitting a physical uplink shared channel transmission including the demodulation reference signal sequence.

A UE for wireless communications is described. The UE may include one or more memories storing processor executable code, and one or more processors coupled with the one or more memories. The one or more processors may be individually or collectively operable to execute the code to cause the UE to receive, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation, generate, using the prime number and the root number as input into a sequence generation function, the demodulation reference signal sequence of the set of demodulation reference signal sequences corresponding to the resource block allocation, and transmit a physical uplink shared channel transmission including the demodulation reference signal sequence.

Another UE for wireless communications is described. The UE may include means for receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation, means for generating, using the prime number and the root number as input into a sequence generation function, the demodulation reference signal sequence of the set of demodulation reference signal sequences corresponding to the resource block allocation, and means for transmitting a physical uplink shared channel transmission including the demodulation reference signal sequence.

A non-transitory computer-readable medium storing code for wireless communications is described. The code may include instructions executable by a processor to receive, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation, generate, using the prime number and the root number as input into a sequence generation function, the demodulation reference signal sequence of the set of demodulation reference signal sequences corresponding to the resource block allocation, and transmit a physical uplink shared channel transmission including the demodulation reference signal sequence.

In some examples of the method, user equipment (UEs), and non-transitory computer-readable medium described herein, the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

In some examples of the method, user equipment (UEs), and non-transitory computer-readable medium described herein, receiving the control signaling may include operations, features, means, or instructions for receiving an indication of an index of a set of multiple indexes, where each index of the set of multiple indexes may be mapped to one of the two or more prime numbers and a respective root number.

In some examples of the method, user equipment (UEs), and non-transitory computer-readable medium described herein, the two or more prime numbers for the resource block allocation may be selected in accordance with a selection rule for selecting the two or more prime numbers based on a proximity of the two or more prime numbers to a quantity of demodulation reference signal tones for the resource block allocation.

In some examples of the method, user equipment (UEs), and non-transitory computer-readable medium described herein, the selection rule indicates a threshold proximity to the quantity of demodulation reference signals.

In some examples of the method, user equipment (UEs), and non-transitory computer-readable medium described herein, the set of demodulation reference signal sequences may be generated using a subset of root numbers for a first prime number of the two or more prime numbers.

In some examples of the method, user equipment (UEs), and non-transitory computer-readable medium described herein, the subset of root numbers may be selected to exclude root numbers that result in high cross-correlated sequences from the set of demodulation reference signal sequences.

In some examples of the method, user equipment (UEs), and non-transitory computer-readable medium described herein, the set of demodulation reference signal sequences may be enumerated using a prime number of the two or more prime numbers and a respective root number and the root number and the prime number indicated via the control signaling correspond to the demodulation reference signal sequence of the set of enumerated demodulated reference signal sequences.

In some examples of the method, user equipment (UEs), and non-transitory computer-readable medium described herein, generating the demodulation reference signal sequence may include operations, features, means, or instructions for generating a first sequence portion using the sequence generation function and cyclically extending the first sequence portion using values of the first sequence portion until a length of a resulting sequence may be equal to a quantity of demodulation reference signal tones in the resource block allocation for the demodulation reference signal sequence.

In some examples of the method, user equipment (UEs), and non-transitory computer-readable medium described herein, the first sequence portion may be cyclically extended based on the resource block allocation being subject to a quantity of excess resource blocks due to bandwidth expansion.

Some examples of the method, user equipment (UEs), and non-transitory computer-readable medium described herein may further include operations, features, means, or instructions for generating a subset of demodulation reference signal sequences using one of the two or more prime numbers results in a quantity of sequences that may be less than a threshold quantity of sequences associated with limiting inter-cell interference.

In some examples of the method, user equipment (UEs), and non-transitory computer-readable medium described herein, the two or more prime numbers may be used to generate the set of demodulation reference signal sequences irrespective of a rule for selecting a single prime number that may be less than a sequence length associated with the resource block allocation.

In some examples of the method, user equipment (UEs), and non-transitory computer-readable medium described herein, generating the demodulation reference signal sequence may include operations, features, means, or instructions for generating, using a Zadoff-Chu function as the sequence generation function, the demodulation reference signal sequence.

A method for wireless communications by a network entity is described. The method may include transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation and receiving, from the UE, a physical uplink shared channel transmission including the demodulation reference signal sequence generated in accordance with the control signaling.

A network entity for wireless communications is described. The network entity may include one or more memories storing processor executable code, and one or more processors coupled with the one or more memories. The one or more processors may be individually or collectively operable to execute the code to cause the network entity to transmit, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation and receive, from the UE, a physical uplink shared channel transmission including the demodulation reference signal sequence generated in accordance with the control signaling.

Another network entity for wireless communications is described. The network entity may include means for transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation and means for receiving, from the UE, a physical uplink shared channel transmission including the demodulation reference signal sequence generated in accordance with the control signaling.

A non-transitory computer-readable medium storing code for wireless communications is described. The code may include instructions executable by a processor to transmit, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation and receive, from the UE, a physical uplink shared channel transmission including the demodulation reference signal sequence generated in accordance with the control signaling.

In some examples of the method, network entities, and non-transitory computer-readable medium described herein, the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

In some examples of the method, network entities, and non-transitory computer-readable medium described herein, transmitting the control signaling may include operations, features, means, or instructions for transmitting an indication of an index that may be mapped to the root number and the prime number, the index being one of a set of multiple indexes and each index of the set of multiple indexes being mapped to one of the two or more prime numbers and a respective root number.

In some examples of the method, network entities, and non-transitory computer-readable medium described herein, the two or more prime numbers for the resource block allocation may be selected in accordance with a selection rule for selecting the two or more prime numbers based on a proximity of the two or more prime numbers to a quantity of demodulation reference signal tones for the resource block allocation.

In some examples of the method, network entities, and non-transitory computer-readable medium described herein, the selection rule indicates a threshold proximity to the quantity of demodulation reference signals.

In some examples of the method, network entities, and non-transitory computer-readable medium described herein, the set of demodulation reference signal sequences may be generated using a subset of root numbers for a first prime number of the two or more prime numbers.

In some examples of the method, network entities, and non-transitory computer-readable medium described herein, the subset of root numbers may be selected to exclude root numbers that result in high cross-correlated sequences from the set of demodulation reference signal sequences.

In some examples of the method, network entities, and non-transitory computer-readable medium described herein, the set of demodulation reference signal sequences may be enumerated using a prime number of the two or more prime numbers and a respective root number and the root number and the prime number indicated via the control signaling correspond to the demodulation reference signal sequence of the set of enumerated demodulated reference signal sequences.

Some examples of the method, network entities, and non-transitory computer-readable medium described herein may further include operations, features, means, or instructions for generating a subset of demodulation reference signal sequences using one of the two or more prime numbers results in a quantity of sequences that may be less than a threshold quantity of sequences associated with limiting inter-cell interference.

In some examples of the method, network entities, and non-transitory computer-readable medium described herein, the two or more prime numbers may be used to generate the set of demodulation reference signal sequences irrespective of a rule for selecting a single prime number that may be less than a sequence length associated with the resource block allocation.

In some examples of the method, network entities, and non-transitory computer-readable medium described herein, each demodulation reference signal sequence of the set of demodulation reference signal sequences may be generated using a Zadoff-Chu function.

### BRIEF DESCRIPTION OF THE DRAWINGS

FIG. 1 illustrates an example of a wireless communications system that supports sequence generation for small resource block allocations of physical uplink shared channel transmissions in accordance with one or more aspects of the present disclosure.

FIG. 2 illustrates an example of a wireless communications system that supports sequence generation for small resource block allocations of physical uplink shared channel transmissions in accordance with one or more aspects of the present disclosure.

FIG. 3 illustrates an example of a table that supports sequence generation for small resource block allocations of physical uplink shared channel transmissions in accordance with one or more aspects of the present disclosure.

FIG. 4 illustrates an example of a process flow that supports sequence generation for small resource block allocations of physical uplink shared channel transmissions in accordance with one or more aspects of the present disclosure.

FIGS. 5 and 6 illustrate block diagrams of devices that support sequence generation for small resource block allocations of physical uplink shared channel transmissions in accordance with one or more aspects of the present disclosure.

FIG. 7 illustrates a block diagram of a communications manager that supports sequence generation for small resource block allocations of physical uplink shared channel transmissions in accordance with one or more aspects of the present disclosure.

FIG. 8 illustrates a diagram of a system including a device that supports sequence generation for small resource block allocations of physical uplink shared channel transmissions in accordance with one or more aspects of the present disclosure.

FIGS. 9 and 10 illustrate block diagrams of devices that support sequence generation for small resource block allocations of physical uplink shared channel transmissions in accordance with one or more aspects of the present disclosure.

FIG. 11 illustrates a block diagram of a communications manager that supports sequence generation for small resource block allocations of physical uplink shared channel transmissions in accordance with one or more aspects of the present disclosure.

FIG. 12 illustrates a diagram of a system including a device that supports sequence generation for small resource block allocations of physical uplink shared channel transmissions in accordance with one or more aspects of the present disclosure.

FIGS. 13 through 15 illustrate flowcharts showing methods that support sequence generation for small resource block allocations of physical uplink shared channel transmissions in accordance with one or more aspects of the present disclosure.

### DETAILED DESCRIPTION

A user equipment (UE) may transmit physical uplink shared channel (PUSCH) transmissions with corresponding demodulation reference signals (DMRSs) that are used for channel estimation and demodulation of PUSCH data at the receiver (e.g., network entity). The UE may generate a DMRS sequence for the DMRS using various techniques, which may depend on the DMRS allocation in the PUSCH and/or the waveform used for the PUSCH transmission. A low peak-to-average power ratio (PAPR) sequence, generally generated using the Zadoff-Chu (ZC) function, is used to improve efficiency in the transmission system by allowing for higher power transmissions without increasing noise. Generation of a sequences using a ZC function may require selection of a prime number that is lower than the length of the DMRS sequence (the number of tones in the DMRS sequence). However, the ZC sequence generation technique, when based on a low resource block (RB) allocation for DMRS, may result in a relatively limited quantity of possible DMRS sequences. Additionally, in some cases, a larger quantity of candidate DMRS sequences may be required to limit inter-cell interference. As such, when a low RB DMRS allocation exists, a UE may be configured to use a set of configured (e.g., not ZC function generated) sequences that are computer generated.

Frequency domain spectrum shaping (FDSS) and bandwidth expansion (BWE) are techniques being used for improving the PAPR properties (e.g., lowering the PAPR) of the PUSCH data. If the PAPR properties are improved, then the PUSCH data may be transmitted with higher power, which may improve network efficiency. However, FDSS and BWE with the limited set of computer generated sequences (for low RB DMRS allocations) may result in insufficient PAPR properties.

Techniques described herein support generation and utilization of DMRS sequences, for low RB DMRS allocation, using a ZC technique that uses two or more prime numbers. As such, devices in a wireless communications system may select from a set of DMRS sequences that are generated using multiple prime numbers (rather than being limited to using a single prime number to generate a set of sequences). This technique may expand the candidate set of DMRS sequences for a low RB allocation, while also not resulting in sequences that result in insufficient PAPR properties (e.g., high PAPR). Additional techniques may be used to filter (e.g., drop) sequences from the candidate set based on limiting high cross-correlated sequences to reduce the possibility of inter-cell interference. Signaling may be used to indicate a sequence that a UE is to use for a PUSCH DMRS. For example, the signaling may indicate a prime number (of two or more prime numbers) and a root number that the UE is to use to generate a DMRS sequence using the ZC algorithm. The UE may generate the DMRS based on the indication and transmit the DMRS in a PUSCH transmission. It should be noted that the techniques described herein may be utilized for DMRS sequence generation and transmission separate from BWE and FDSS techniques. These and other techniques are described in further detail with respect to the figures.

Aspects of the disclosure are initially described in the context of wireless communications systems. Aspects of the present disclosure are further described with respect to a wireless communications system that supports BWE and FDSS, a table used for signaling a DMRS sequence, and a process flow. Aspects of the disclosure are further illustrated by and described with reference to apparatus diagrams, system diagrams, and flowcharts that relate to sequence generation for small resource block allocations of physical uplink shared channel transmissions.

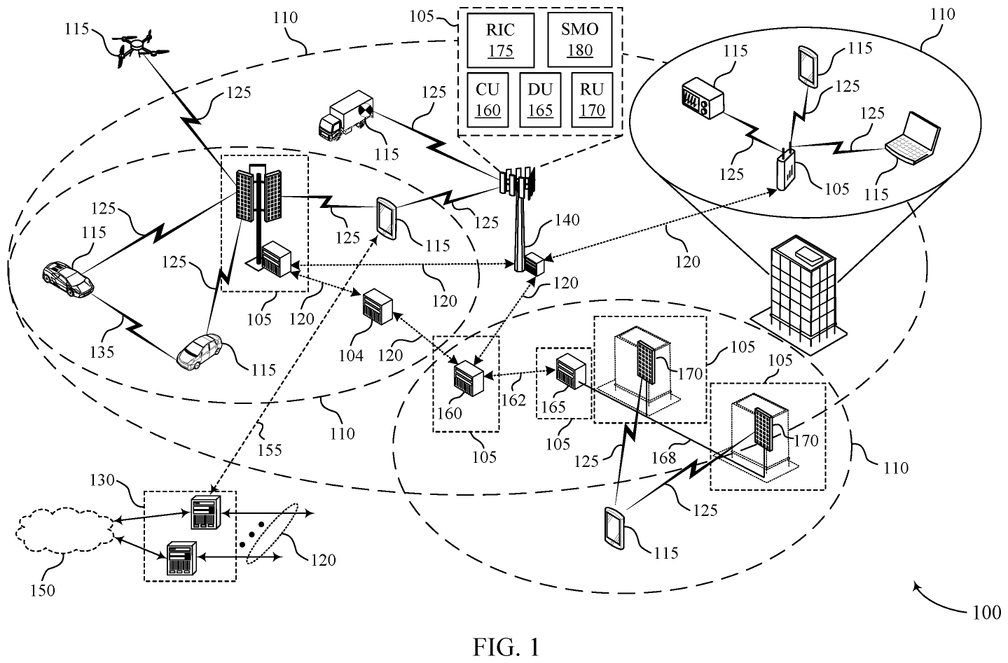

FIG. 1 illustrates an example of a wireless communications system 100 that supports sequence generation for small resource block allocations of physical uplink shared channel transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sequence generation for small resource block allocations of physical uplink shared channel transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, the UEs 115 may transmit PUSCH transmissions that include DMRSs that are used for channel estimation and demodulation of the PUSCH data at the receiver (e.g., a network entity 105). The devices may select a DMRS sequence for the DMRS based on factors such as a waveform used to transmit the PUSCH and/or a RB allocation for the DMRS. Devices of the wireless communications system 100 may also use FDSS and BWE to improve PAPR properties in transmissions, which may support increased communication power while limiting or reducing additional noise or interference. However, some DMRS sequences (e.g., computer generated sequences for low RB DMRS allocations), when used in conjunction with FDSS and BWE techniques, may have limited or inadequate PAPR properties.

Techniques described herein support generation of a set of DMRS sequences using a sequence generation function and two or more prime numbers, rather than a single prime number, as use of a single prime number for sequence generation may be a restriction or rule in some current systems. The described techniques may result in an increased quantity of candidate DMRS sequences which have improved PAPR properties. Additionally, in some cases, candidate DMRS sequences that are generated using multiple prime numbers may be filtered to exclude high cross-correlated sequences as to reduce a possibility of inter-cell interference. Additionally, cyclic extension may be used to extend the candidate sequences to an adequate sequence length (e.g., based on the RB allocation, bandwidth extension, or both). In some examples, a network entity 105 may use control signaling to indicate a prime number (of two or more prime numbers) and a root number that a UE 115 is to use to generate a DMRS sequence. For example, the network entity 105 may indicate an index corresponding to a prime number/root number pair of a table enumerating a set of pairs corresponding to a set of sequences.

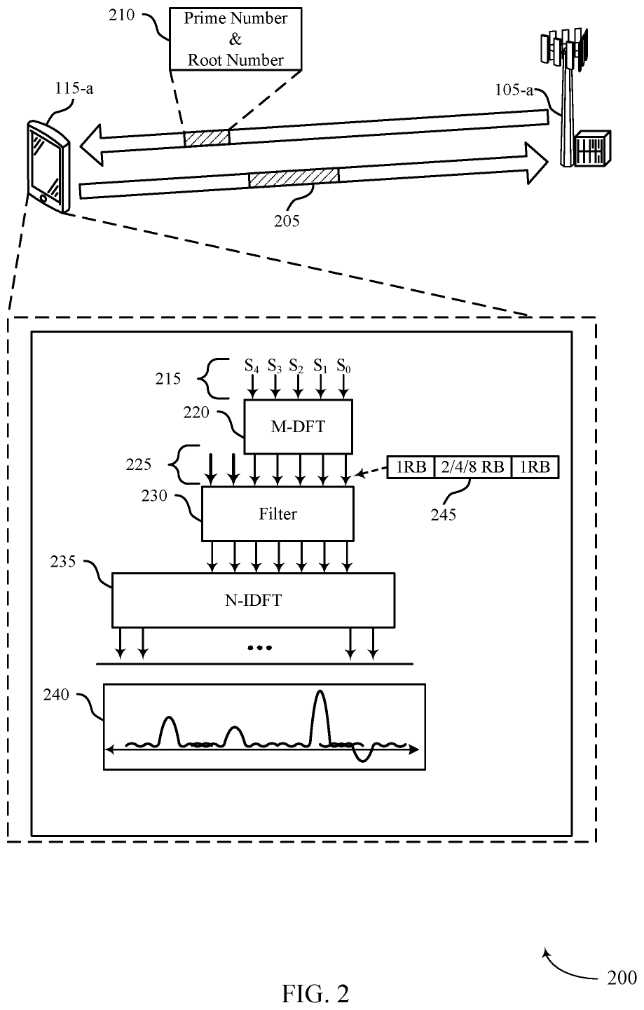

FIG. 2 illustrates an example of a wireless communications system 200 that supports sequence generation for small resource block allocations of physical uplink shared channel transmissions in accordance with one or more aspects of the present disclosure. The wireless communications system 200 includes a UE 115-a and a network entity 105-a, which may be examples of the corresponding devices as described with respect to FIG. 1. Specifically, wireless communications system 200 illustrates example communications between the UE 115-a and the network entity 105-a.

The UE 115-a may be configured to transmit PUSCH transmissions (e.g., a PUSCH transmission 205) to the network entity 105-a, and the PUSCH transmissions may include DMRSs that are used by the network entity 105-a for channel estimation and demodulation of the PUSCH data. The UE 115-a may use different types of DMRS sequences for PUSCH transmissions. A first type of sequence is a pseudo-noise (PN) sequence-based Quadrature Phase Shift Keying (QPSK) DMRS for cyclic prefix (CP)-OFDM PUSCH. This type of sequence may be generated in the frequency domain and may result in a comb structure in the frequency domain. A second type of sequence is a low PAPR sequence Type 1, which is primarily based on the Zadoff Chu sequence for discrete Fourier transform spread OFDM (DFT-S-OFDM) PUSCH. This type of sequence is generated in the frequency domain, and some extension may be used because the ZC sequence may utilize a largest prime smaller than the required length of the sequence. Additionally, the Low PAPR sequence Type 1 sequence results in a comb structure in the frequency domain. For smaller lengths (e.g., 6, 12, 18, or 24 tones) a computer generated sequence (CGS) may be used instead of the ZC generated sequences. A third type of sequence is a low PAPR sequence Type 2, which is a Pi/2 binary phase-shift keying (BPSK)-based DFT-S-OFDM PUSCH that is generated in the time domain. This type of sequence may not have a uniform power distribution in the frequency domain. In this case, a gold sequence generator may be reused, and for small target lengths, CGS may be used.

As noted, the UE 115-a may use the different type of sequences based on the type of waveform that is to be used for the PUSCH transmission. Further, for the low PAPR sequence Type 1, the UE 115-a may use a pre-generated sequence (e.g., CGS) of a set when the length of the DMRS to be transmitted is low. The UE 115-a may use the CGS for low length sequences because when using the ZC technique, the UE 115-a is configured to apply a rule for selecting a single prime number that is less than a sequence length associated with the RB allocation for the DMRS. More particularly, the UE 115-a determines the length of the DMRS based on the RB allocation and selects a prime number that is less than the length. The prime number is then used to generate the DMRS sequence using the ZC algorithm. When the length of the DMRS is low (e.g., 6, 12, 18, or 24 tones), a prime number less than the length results in a limited quantity of ZC based DMRS sequences. That is, the quantity of sequences generated by the ZC algorithm may depend on the length of the target sequence. Thus, when the length of the DMRS is low (e.g., less than 30 tones), then the ZC algorithm may generate a limited quantity of sequences. Moreover, when cells are distributed in a high-density environment, it may be beneficial to have a larger quantity of candidate DMRS sequences from which to select a sequence in order to reduce a possibility of inter-cell interference. More particularly, a low quantity of candidate DMRS sequences may result in UEs 115 in neighboring cells selecting or using the same sequence, which may cause inter-cell interference. As such, rather than using the ZC sequence generation techniques for a small DMRS RB allocation, a UE may be configured to identify one of a set of computer generated sequence, and the set of computer generated sequences has a quantity of sequences (e.g., 30) that is greater than the quantity of sequences resulting from the ZC technique based on the single prime number that is less than the length. Thus, a UE uses one of a set of a computer generated sequences to serve particular DMRS RB allocations.

Some techniques may be used to improve uplink coverage. For example, FDSS and BWE may be used to improve uplink coverage for PUSCH transmissions. In some examples, for DFT waveforms, the modulation symbols (e.g., the data of the PUSCH) are loaded into a DFT block, and the output is mapped to a larger inverse-DFT (I-DFT) block to produce data in the time domain. As illustrated in FIG. 2, data 215, such as a DMRS or PUSCH data is input to a DFT block 220 resulting in output of M tones. With the BWE technique, the M tones are cyclically extended to produce M+K tones, as shown at 225. The M+K tones are input into a filtering operation 230, which may be an example of a dot product (e.g., with a real or complex scalar) in the frequency domain that replicates a pulse shaping filter. The output of the filtering operation (e.g., frequency domain coefficients for a pulse shaping filter) is input into N-IDFT block 235. A resulting time domain waveform 240 may be produced, and the waveform 240 has improved PAPR properties based on the FDSS and BWE techniques. More particularly, the waveform 240 may have reduced overlap between pulses due to suppressed sidelobes, which results in better PAPR properties (e.g., lower PAPR).

As described, the FDSS and BWE techniques may be applied to the DMRS to improve PAPR properties of the DMRS. For example, multiple options may be considered for DMRS sequences for low PAPR type 1 DMRS sequences. In a first option, a DMRS sequence is generated considering the quantity of physical resource blocks (PRBs) in the inband plus the extension. The sequence length depends on the quantity of PRBs in the inband plus the extension. In a second option, a DMRS sequence is generated considering the quantity of PRBs in the inband (no extension). The sequence length depends on the quantity of PRBs in the inband. The sequence is then cyclically extended to span the PRBs in the extension. In a third option, a DMRS sequence is generated considering the quantity of PRBs in the inband (no extension). The sequence length depends on the quantity of PRBs in the inband, and DMRS extension is applied similar to data to span the PRBs in the extension.

As illustrated at 245, a DMRS may be allocated with a RB allocation (e.g., two, four, or eight RBs), such that the DMRS has a length of M tones, and the DRMS may then extended with one RB on either side (e.g., extended with K tones). Utilization of the computer generated sequences (associated with low DMRS RB allocation scenarios) in the above described FDSS and BWE techniques may result in DMRS sequences that do not satisfy PAPR requirements. That is, the computer generated sequences may not be suitable for FDSS and BWE as the resulting DMRSs may have insufficient or undesirable PAPR properties. As such, it is desirable to identify DMRS sequence generation techniques that result in sequences, for low RB allocations, that have low PAPR.

Techniques described herein support DMRS sequence generation for smaller RB allocations (e.g., 2, 3, or 4 RB allocations), and the generated DMRS sequences may be suitable for the FDSS and the BWE techniques described with respect to FIG. 2 in order to improve PAPR properties. Note that the techniques described herein may be used for DMRS sequence generation separate from BWE and FDSS. According to techniques described herein, a set of DMRS sequences may be configured for low RB DMRS allocations, and the set of sequences may be based on two or more prime numbers (e.g., rather than one).

In an example, if the UE 115-a is allocated 3 RB for DMRS, then length of the DMRS sequence is to be 18 tones based on each RB having 12 tones and the DMRS having a comb pattern (e.g., occupies every other tone). More particularly, 3 RB results in 36 tones, and because the DMRS occupies every other tone, 36/2=18. If using the rule that the UE 115-a is to select a prime number less than the length of 18, the UE 115 mays select N_{zc} (the length in the ZC function) of 17, as 17 is largest prime number less than 18. However, using 17 to generate the sequence set results in 16 sequences, which is not enough to satisfy a threshold (e.g., 30 sequences) based on reducing inter cell interference. Thus, according to techniques described herein, the set of candidate sequences is generated using the two (or more) prime numbers proximal to the length of 17. Accordingly, in the example of 3 RBs, the prime numbers used to generate candidate DMRS sequences are 17 and 19. As such, the prime numbers are not restricted to being less than the length. Additionally, because BWE may be applicable, the prime number 19 may also be used when the 3 RBs are allocated for DMRS (e.g., 3 RB allocation plus 1 RB on either side of the 3 RB DMRS allocation).

Additionally, the use of two (or more) prime numbers to generate a set of DMRS sequences for DMRS RB allocation may result in additional sequences above a threshold. For example, use of prime numbers 17 and 19 results in 34 sequences using the ZC function, which is 4 extra sequences over a threshold 30. In such cases, 4 of the sequences may be dropped. For example, sequences that have a relatively high cross-correlation with other sequences may be dropped from the candidate DMRS sequence set in order to reduce inter-cell interference.

In another example, if the DMRS allocation is 4 RBs, then the DMRS length is 24 tones (48 total tones for the 4 RB allocation divided by two equals 24). In this example, if the UE 115-a uses the rule requiring selection of the prime number less than the length, generation of the set of sequences using the prime number of 19 results in 18 sequences, which is less than the threshold target of 30 (or another threshold). As such, according to the techniques described herein, the set of DMRS sequences are generated using the prime numbers 19 and 23, which are the two closest prime numbers to the target DMRS length of 24 (e.g., 19 and 23 are the proximal prime numbers to 24). Using the prime numbers 19 and 23 and the ZC generation function results in forty total sequences. In this example, sequences may be dropped in order to filter out high cross-correlated sequences. For example, ten sequences may be dropped to satisfy the target of thirty sequences.

In some examples, as described herein, some of the sequences are to be extended to meet a DMRS allocation with a RB extension for BWE. In such cases, the sequences may be cyclically extended to satisfy the DMRS length plus the RB extension. For example, in case of the target DMRS length of 24 plus a two RB extension, selecting a DMRS sequence based on the prime number 23 may result in a sequence length of 23. Further, the two RB extension may result in twelve additional tones. Thus, the total DMRS length plus extension is 36. In such cases, the sequence (having a length of 23) may be cyclically extended to reach the 36 tone length. These cyclic extension techniques may be used for various DMRS plus extension lengths and various ZC generated sequences.

Thus, the devices (e.g., the UE 115-a and the network entity 105-a) may rely on the ZC function to generate candidate DMRS sequences even in low DMRS RB allocation scenarios, which may result in candidate DMRS sequences which are associated with low PAPR relative to the computer generated sequences that may result in high PAPR.

In order to support the utilization of the DMRS sequence set based on the two (or more) prime numbers as described herein, the network entity 105-a may transmit control signaling 210, which indicates a prime number and a root number that are to be used for generating a DMRS sequence for a RB allocation. In such cases, the RB allocation may be associated with set of DMRS sequences that are generated using two or more prime numbers (according to the techniques described herein). That is, a set of possible sequences for the RB allocation may be associated multiple prime numbers. The control signaling 210 indicates one of the prime numbers and the root numbers that are used, with the sequence generation function (e.g., the ZC function), to generate the DMRS sequence that is to be used for the DMRS to be transmitted with the PUSCH transmission 205.

In some examples, the UE 115-a may be configured with or access a table that enumerates prime number/root number pairs with a set of indices. In such cases, the network entity 105-a may signal an index that corresponds to a prime number (e.g., of two or more prime numbers) and the root number that the UE 115-a is to use for generating the DMRS sequence. In other examples, the control signaling 210 may include an explicit indication of the root number and the prime number that the UE 115-a is to use for generation of the DMRS sequence. After generation of the sequence, the UE 115-a may cyclically extend the generated sequence until the desired length (e.g., DMRS length or DMRS plus extension length) is achieved.

As such, the techniques described herein support, for any N RB allocation, construction of a set S_{N} of DMRS sequences formed using two or more sets of ZC sequences that have different lengths (lᵢ). The two or more sets of ZC sequences are generated by setting the lengths lᵢ to be respective prime numbers. Further, the list of lᵢ is enumerated or alternately, set to be the set of P nearest primes to N′ where N′ is the number of DMRS tones in a N RB allocation. Additionally, For every chosen length lᵢ, a subset Rᵢ of the roots from the set of possible roots {1, 2, . . . lᵢ−1} are chosen to form the set of sequence in S_{N}. Further, the subsets Rᵢ may be chosen to minimize the cross-correlation across the set of sequences in S. The set S_{N} may be enumerated as a set of pairs with each pair containing the length and the root index of the corresponding ZC sequence. When the length lᵢ is less than the DMRS tones in a N RB allocation, the sequence may be cyclically extended until the extended sequence is the same length as the number of DMRS tones in a N RB allocation. Additionally, for any N RB allocation with K RB excess bandwidths (e.g., for BWE), the length lᵢ sequence is cyclically extended until the extended sequence is the same length as the number of DMRS tones over the N+K RBs.

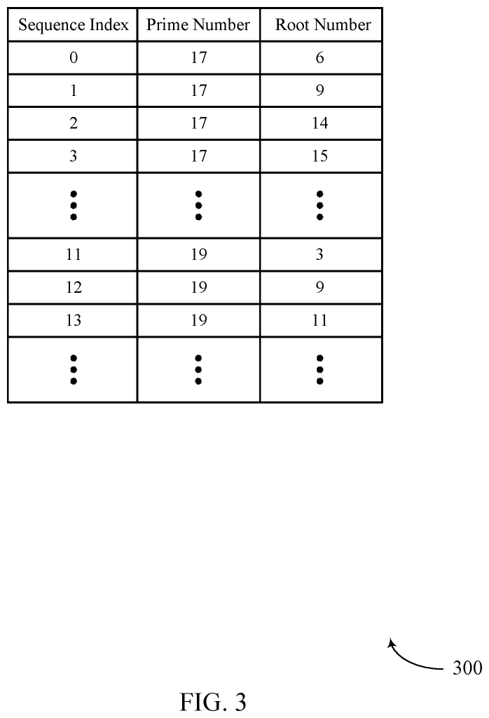

FIG. 3 illustrates an example of a table 300 that supports sequence generation for small resource block allocations of physical uplink shared channel transmissions in accordance with one or more aspects of the present disclosure. The table 300 may correspond to a set of DMRS sequences that devices of a wireless communication system may use for PUSCH transmission. For example, the UEs 115 and the network entities 105 as described with respect to FIGS. 1 and 2 may utilize the table for signaling and/or generating DMRS sequences for PUSCH transmissions as described herein.

The table 300 enumerates prime numbers and root numbers that may be used for a DMRS sequence generation for a 3 RB or 4 RB DMRS allocation. The table includes sequences associated with two different prime numbers: 17 and 19. Additionally, the table may exclude prime number/root number pairs that result in sequences that are highly cross-correlated with other sequences. As such, root numbers corresponding to one or more of the prime numbers may be excluded. To identify and exclude the sequences based on high cross-correlation, each sequence corresponding to the prime umbers may be generated and processed to determine high cross-correlation. In some examples, sequences are removed until a threshold quantity of sequences is satisfied (e.g., 30). The UE 115-a may be configured with or may access the resulting table (e.g., table 300). It should be noted that table 300 may not reflect the sequences with the lowest cross-correlation (for prime numbers 17 and 19), and other tables with prime number and root number pairs are contemplated within the scope of the present disclosure. Additionally, different tables with two or more prime numbers may be used for different RB allocations or different use cases.

In some examples, the network entity 105-a may use control signaling to indicate which of the sequences of the set of DMRS sequences to use. For example, the control signaling may include an sequence index corresponding to one of the prime number/root number pairs that are to be input into the sequence generation function (e.g., ZC function) to generate the sequence for the DMRS. The UE 115 may then cyclically extend the generated sequence until a desired length is achieved. More particularly, the UE 115 may generate a portion of the DMRS sequence using the function and the prime number/root number pair. The UE 115 may then, using the generated portion (in a cyclic manner), concatenate sequence values of the portion until the desired length is achieved. In some cases, as described herein, rather than using a sequence index, the network entity 105 may explicitly signal the prime number and the root number to use for DMRS sequence generation.

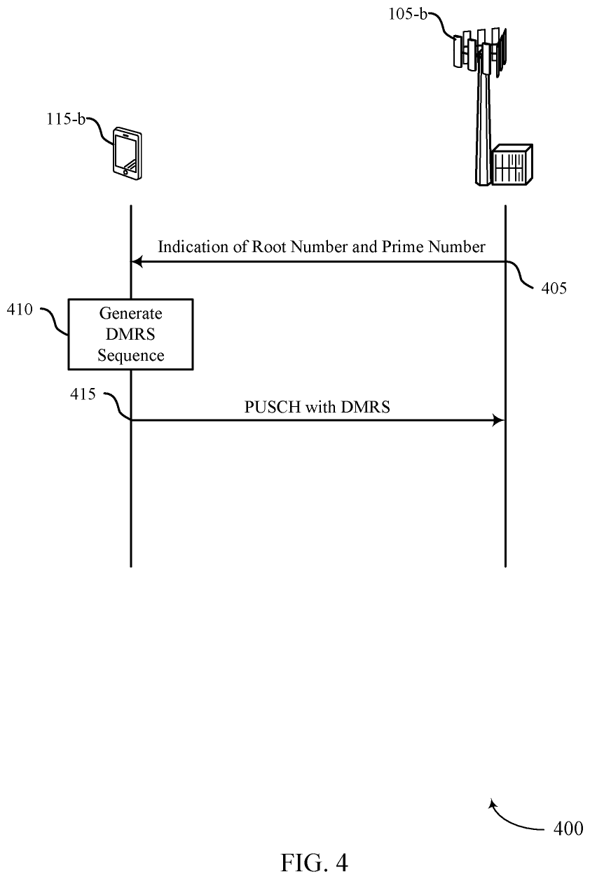

FIG. 4 illustrates an example of a process flow 400 that supports sequence generation for small resource block allocations of physical uplink shared channel transmissions in accordance with one or more aspects of the present disclosure. The process flow 400 may implement aspects of the wireless communications system 100 or may be implemented by aspects of the wireless communications system 200. For example, the process flow 400 includes a UE 115-b and a network entity 105-b, which may be examples of the corresponding devices described with respect to FIGS. 1 through 3. In the following description of the process flow 400, the operations between the UE 115-b and the network entity 105-b may be transmitted in a different order than the example order shown, or the operations performed may be performed in different orders or at different times. Some operations may also be omitted from the process flow 400, and other operations may be added to the process flow 400.

At 405, the network entity 105-b may transmit, and the UE 115-b may receive, for generation of a demodulation reference signal sequence corresponding to a resource block allocation, control signaling indicative of a selection of a root number and a prime number. The prime number may be one of two or more prime numbers used to generate a set of demodulation reference signal sequences (e.g., S_{N}) for the resource block allocation. In some examples, the control signaling may indicate an index of a plurality of indexes, where each index of the plurality of indexes is mapped to one of the two or more prime numbers and a respective root number. That is, the UE 115-b may be configured with a table (or listing) including a plurality of indexes that enumerate a prime number (of the two or more prime numbers) root number pair, and the control signaling may indicate one of the indices. The control signaling may be an example of a radio resource control (RRC) signal, a medium access control layer control element (MAC-CE) signal, a downlink control information (DCI) signal, or a combination thereof.

The set of demodulation reference signal sequences for the resource block allocation may include a first subset of sequences having a first length (lᵢ) and generated using a first prime number of the two or more prime numbers and a second subset of sequences having a second length (lᵢ) and generated using a second prime numbers of the two or more prime numbers. Additionally, the two or more prime numbers for the resource block allocation are selected in accordance with a selection rule for selecting the two or more prime numbers based at least in part on a proximity of the two or more prime numbers to a quantity of demodulation reference signal tones (e.g., N′) for the resource block allocation N. In some examples, the selection rule indicates a threshold proximity to the quantity, and the prime numbers (P) may be selected based on the threshold proximity. Additionally, the set of demodulation reference signal sequences is generated using a subset of root numbers for a first prime number of the two or more prime numbers, and the subset of root numbers (e.g., Rᵢ) is selected to exclude root numbers that result in high cross-correlated sequences from the set of demodulation reference signal sequences. More particularly, root number/prime number pairs that result in high cross-correlated sequences (relative to other sequences) may not be included in a table or may not be associated with an index for signaling.

In some examples, the set of demodulation reference signal sequences (e.g., S_{N}) are enumerated using a prime number of the two or more prime numbers and a respective root number, and the root number and the prime number indicated via the control signaling correspond to the demodulation reference signal sequence of the set of enumerated demodulated reference signal sequences. Further, the two or more prime numbers are used to generate the set of demodulation reference signal sequences irrespective of a rule for selecting a single prime number that is less than a sequence length associated with the resource block allocation. That is, the UE 115-b may disregard a rule that specifies that the UE 115-b is select a single prime number that is less than the length of the DMRS sequence. Further, if a subset of DMRS sequences was generated using one of the prime numbers, the resulting quantity may be less than a threshold quantity of sequences (e.g., less than 30 sequences) associated with limiting inter-cell interference.

At 410, the UE 115-b may generate, using the prime number and the root number as input into a sequence generation function, the demodulation reference signal sequence of the set of demodulation reference signal sequences corresponding to the resource block allocation. In some examples, the UE 115-b generates a first sequence portion using the sequence generation function and cyclically extending the first sequence portion using values of the first sequence portion until a length of a resulting sequence is equal to a quantity of demodulation reference signal tones in the resource block allocation for the demodulation reference signal sequence. That is, if the generated sequence portion is less than a length of the DMRS (based on the RB allocation), then the UE 115-b may cyclically extend the sequence until the sequence equals the length of the DMRS. In some examples, the first sequence portion is cyclically extended based at least in part on the resource block allocation being subject to a quantity of excess resource blocks (e.g., K RB excess) due to bandwidth expansion (e.g., BWE). The UE 115-b may generate the DMRS sequence using a Zadoff-Chu function as the sequence generation function.

At 415, the UE 115-b may transmit, and the network entity 105-b may receive a physical uplink shared channel transmission including the demodulation reference signal sequence.

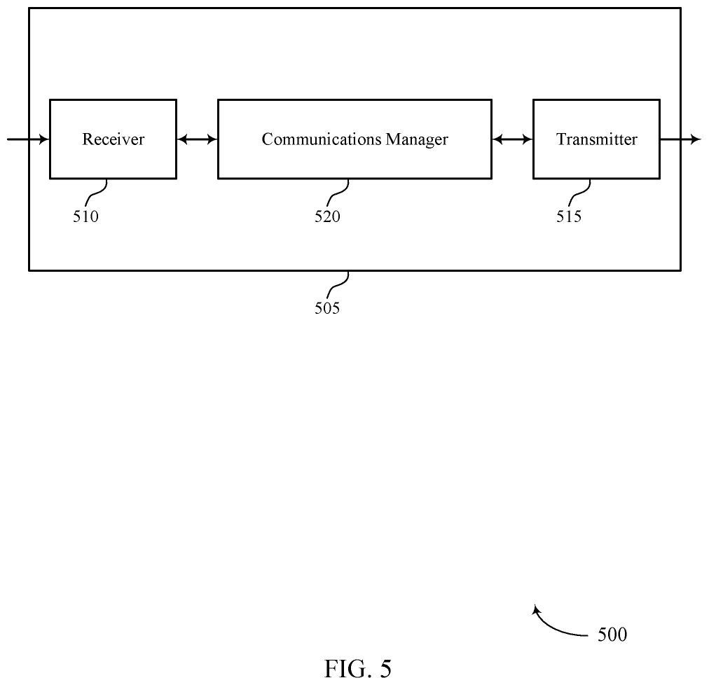

FIG. 5 illustrates a block diagram 500 of a device 505 that supports sequence generation for small resource block allocations of physical uplink shared channel transmissions in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to sequence generation for small resource block allocations of physical uplink shared channel transmissions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sequence generation for small resource block allocations of physical uplink shared channel transmissions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of sequence generation for small resource block allocations of physical uplink shared channel transmissions as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation. The communications manager 520 may be configured as or otherwise support a means for generating, using the prime number and the root number as input into a sequence generation function, the demodulation reference signal sequence of the set of demodulation reference signal sequences corresponding to the resource block allocation. The communications manager 520 may be configured as or otherwise support a means for transmitting a physical uplink shared channel transmission including the demodulation reference signal sequence.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for improved power efficiency and improved utilization of communication resources. For example, by implementing the DMRS sequence generation techniques described herein, devices may be able to transmit with increased power, while limiting negative impacts of increased power such as interference and noise.

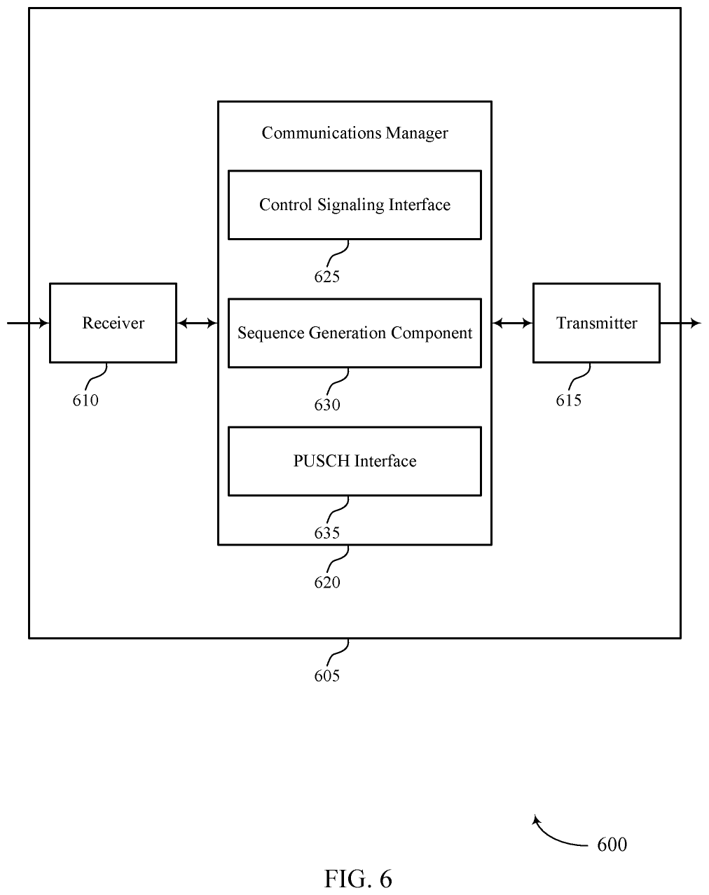

FIG. 6 illustrates a block diagram 600 of a device 605 that supports sequence generation for small resource block allocations of physical uplink shared channel transmissions in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to sequence generation for small resource block allocations of physical uplink shared channel transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sequence generation for small resource block allocations of physical uplink shared channel transmissions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of sequence generation for small resource block allocations of physical uplink shared channel transmissions as described herein. For example, the communications manager 620 may include a control signaling interface 625, a sequence generation component 630, an PUSCH interface 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The control signaling interface 625 may be configured as or otherwise support a means for receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation. The sequence generation component 630 may be configured as or otherwise support a means for generating, using the prime number and the root number as input into a sequence generation function, the demodulation reference signal sequence of the set of demodulation reference signal sequences corresponding to the resource block allocation. The PUSCH interface 635 may be configured as or otherwise support a means for transmitting a physical uplink shared channel transmission including the demodulation reference signal sequence.

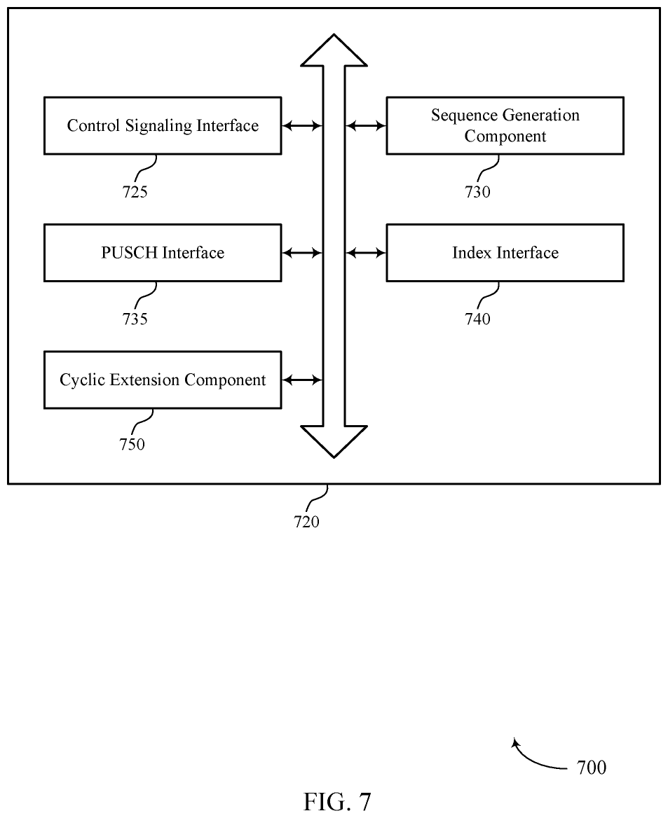

FIG. 7 illustrates a block diagram 700 of a communications manager 720 that supports sequence generation for small resource block allocations of physical uplink shared channel transmissions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of sequence generation for small resource block allocations of physical uplink shared channel transmissions as described herein. For example, the communications manager 720 may include a control signaling interface 725, a sequence generation component 730, an PUSCH interface 735, an index interface 740, a cyclic extension component 750, or any combination thereof. Each of these components may communicate, directly or indirectly, with one another (e.g., via one or more buses).

The communications manager 720 may support wireless communications at a UE in accordance with examples as disclosed herein. The control signaling interface 725 may be configured as or otherwise support a means for receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation. The sequence generation component 730 may be configured as or otherwise support a means for generating, using the prime number and the root number as input into a sequence generation function, the demodulation reference signal sequence of the set of demodulation reference signal sequences corresponding to the resource block allocation. The PUSCH interface 735 may be configured as or otherwise support a means for transmitting a physical uplink shared channel transmission including the demodulation reference signal sequence.

In some examples, the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

In some examples, to support receiving the control signaling, the index interface 740 may be configured as or otherwise support a means for receiving an indication of an index of a set of multiple indexes, where each index of the set of multiple indexes is mapped to one of the two or more prime numbers and a respective root number.

In some examples, the two or more prime numbers for the resource block allocation are selected in accordance with a selection rule for selecting the two or more prime numbers based on a proximity of the two or more prime numbers to a quantity of demodulation reference signal tones for the resource block allocation.

In some examples, the selection rule indicates a threshold proximity to the quantity of demodulation reference signals.

In some examples, the set of demodulation reference signal sequences is generated using a subset of root numbers for a first prime number of the two or more prime numbers.

In some examples, the subset of root numbers is selected to exclude root numbers that result in high cross-correlated sequences from the set of demodulation reference signal sequences.

In some examples, the set of demodulation reference signal sequences are enumerated using a prime number of the two or more prime numbers and a respective root number. In some examples, the root number and the prime number indicated via the control signaling correspond to the demodulation reference signal sequence of the set of enumerated demodulated reference signal sequences.

In some examples, to support generating the demodulation reference signal sequence, the cyclic extension component 750 may be configured as or otherwise support a means for generating a first sequence portion using the sequence generation function and cyclically extending the first sequence portion using values of the first sequence portion until a length of a resulting sequence is equal to a quantity of demodulation reference signal tones in the resource block allocation for the demodulation reference signal sequence.

In some examples, the first sequence portion is cyclically extended based on the resource block allocation being subject to a quantity of excess resource blocks due to bandwidth expansion.

In some examples, generating a subset of demodulation reference signal sequences using one of the two or more prime numbers results in a quantity of sequences that is less than a threshold quantity of sequences associated with limiting inter-cell interference.

In some examples, the two or more prime numbers are used to generate the set of demodulation reference signal sequences irrespective of a rule for selecting a single prime number that is less than a sequence length associated with the resource block allocation.

In some examples, to support generating the demodulation reference signal sequence, the sequence generation component 730 may be configured as or otherwise support a means for generating, using a Zadoff-Chu function as the sequence generation function, the demodulation reference signal sequence.

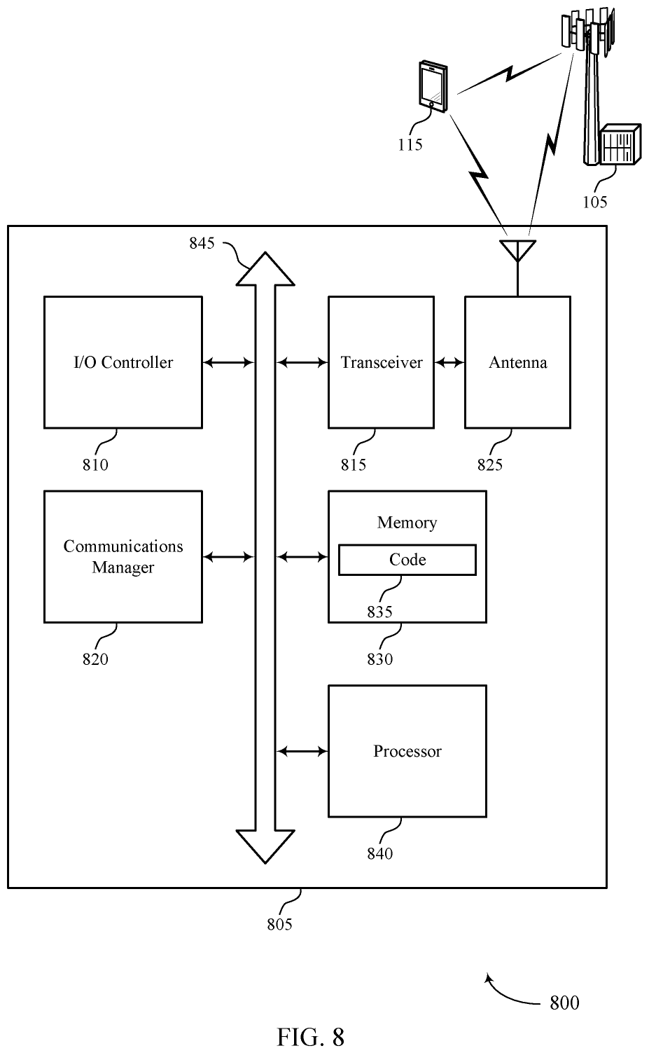

FIG. 8 illustrates a diagram of a system 800 including a device 805 that supports sequence generation for small resource block allocations of physical uplink shared channel transmissions in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting sequence generation for small resource block allocations of physical uplink shared channel transmissions). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation. The communications manager 820 may be configured as or otherwise support a means for generating, using the prime number and the root number as input into a sequence generation function, the demodulation reference signal sequence of the set of demodulation reference signal sequences corresponding to the resource block allocation. The communications manager 820 may be configured as or otherwise support a means for transmitting a physical uplink shared channel transmission including the demodulation reference signal sequence.

By including or configuring the communications manager 820 in accordance with examples as described herein, the device 805 may support techniques for improved power efficiency and improved utilization of communication resources. For example, by implementing the DMRS sequence generation techniques described herein, devices may be able to transmit with increased power, while limiting negative impacts of increased power such as interference and noise.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of sequence generation for small resource block allocations of physical uplink shared channel transmissions as described herein, or the processor 840 and the memory 830 may be otherwise configured to perform or support such operations.

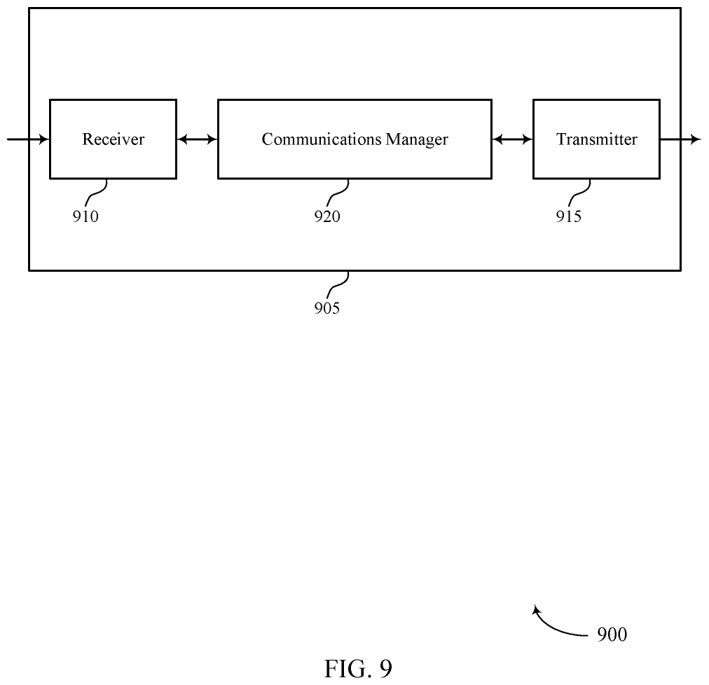

FIG. 9 illustrates a block diagram 900 of a device 905 that supports sequence generation for small resource block allocations of physical uplink shared channel transmissions in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of sequence generation for small resource block allocations of physical uplink shared channel transmissions as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation. The communications manager 920 may be configured as or otherwise support a means for receiving, from the UE, a physical uplink shared channel transmission including the demodulation reference signal sequence generated in accordance with the control signaling.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for improved power efficiency and improved utilization of communication resources. For example, by implementing the DMRS sequence generation techniques described herein, devices may be able to transmit with increased power, while limiting negative impacts of increased power such as interference and noise.

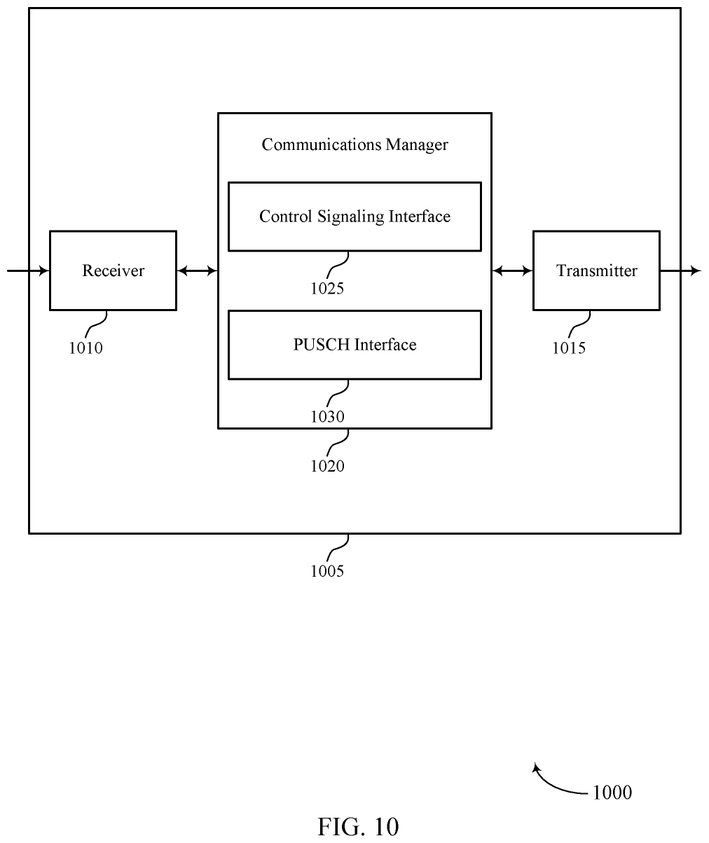

FIG. 10 illustrates a block diagram 1000 of a device 1005 that supports sequence generation for small resource block allocations of physical uplink shared channel transmissions in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of sequence generation for small resource block allocations of physical uplink shared channel transmissions as described herein. For example, the communications manager 1020 may include a control signaling interface 1025 an PUSCH interface 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The control signaling interface 1025 may be configured as or otherwise support a means for transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation. The PUSCH interface 1030 may be configured as or otherwise support a means for receiving, from the UE, a physical uplink shared channel transmission including the demodulation reference signal sequence generated in accordance with the control signaling.

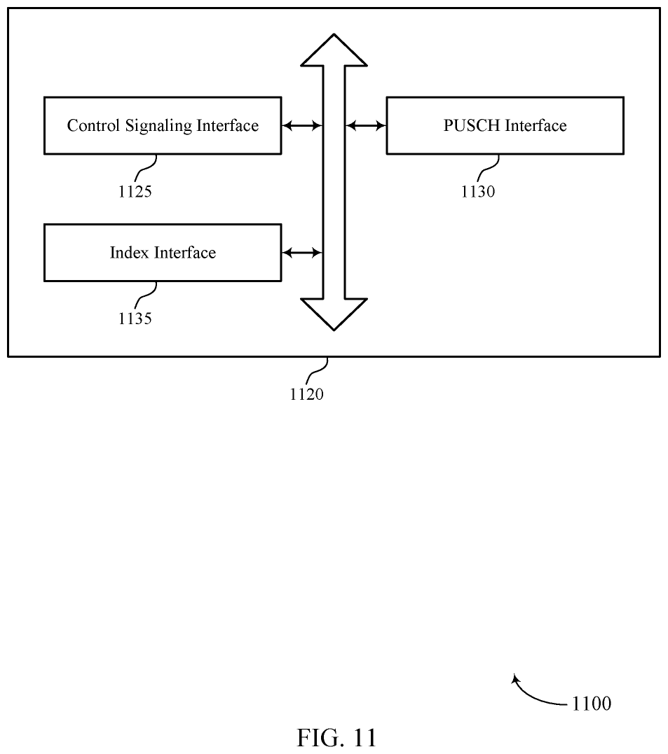

FIG. 11 illustrates a block diagram 1100 of a communications manager 1120 that supports sequence generation for small resource block allocations of physical uplink shared channel transmissions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of sequence generation for small resource block allocations of physical uplink shared channel transmissions as described herein. For example, the communications manager 1120 may include a control signaling interface 1125, an PUSCH interface 1130, an index interface 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The control signaling interface 1125 may be configured as or otherwise support a means for transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation. The PUSCH interface 1130 may be configured as or otherwise support a means for receiving, from the UE, a physical uplink shared channel transmission including the demodulation reference signal sequence generated in accordance with the control signaling.

In some examples, the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

In some examples, to support transmitting the control signaling, the index interface 1135 may be configured as or otherwise support a means for transmitting an indication of an index that is mapped to the root number and the prime number, the index being one of a set of multiple indexes and each index of the set of multiple indexes being mapped to one of the two or more prime numbers and a respective root number.

In some examples, the two or more prime numbers for the resource block allocation are selected in accordance with a selection rule for selecting the two or more prime numbers based on a proximity of the two or more prime numbers to a quantity of demodulation reference signal tones for the resource block allocation.

In some examples, the selection rule indicates a threshold proximity to the quantity of demodulation reference signals.

In some examples, the set of demodulation reference signal sequences is generated using a subset of root numbers for a first prime number of the two or more prime numbers.

In some examples, the subset of root numbers is selected to exclude root numbers that result in high cross-correlated sequences from the set of demodulation reference signal sequences.

In some examples, the set of demodulation reference signal sequences are enumerated using a prime number of the two or more prime numbers and a respective root number. In some examples, the root number and the prime number indicated via the control signaling correspond to the demodulation reference signal sequence of the set of enumerated demodulated reference signal sequences.

In some examples, generating a subset of demodulation reference signal sequences using one of the two or more prime numbers results in a quantity of sequences that is less than a threshold quantity of sequences associated with limiting inter-cell interference.

In some examples, the two or more prime numbers are used to generate the set of demodulation reference signal sequences irrespective of a rule for selecting a single prime number that is less than a sequence length associated with the resource block allocation.

In some examples, each demodulation reference signal sequence of the set of demodulation reference signal sequences is generated using a Zadoff-Chu function.

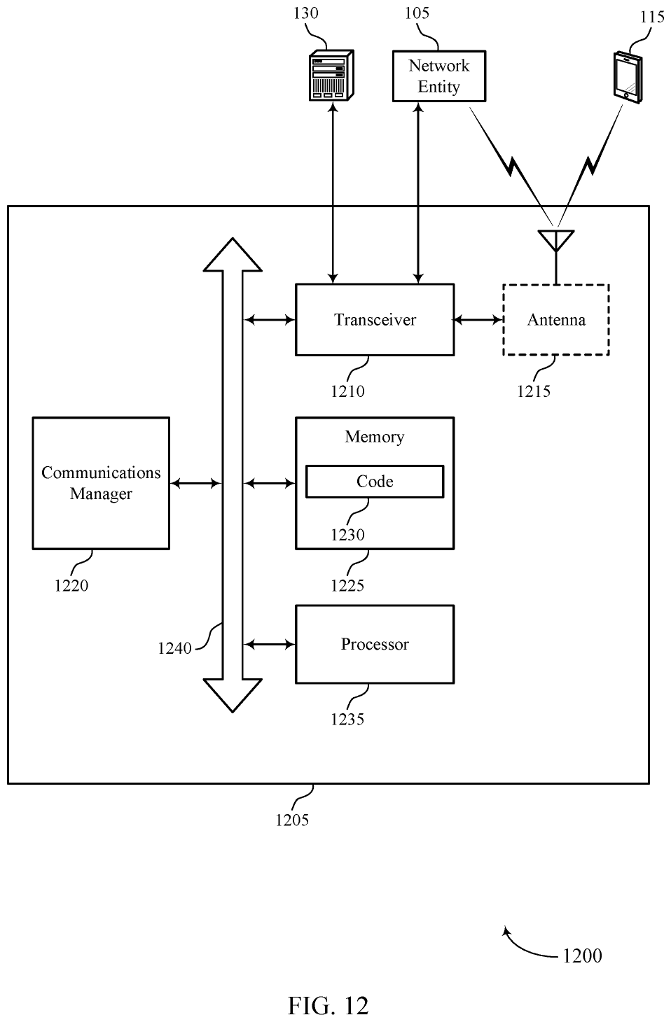

FIG. 12 illustrates a diagram of a system 1200 including a device 1205 that supports sequence generation for small resource block allocations of physical uplink shared channel transmissions in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting sequence generation for small resource block allocations of physical uplink shared channel transmissions). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation. The communications manager 1220 may be configured as or otherwise support a means for receiving, from the UE, a physical uplink shared channel transmission including the demodulation reference signal sequence generated in accordance with the control signaling.

By including or configuring the communications manager 1220 in accordance with examples as described herein, the device 1205 may support techniques for improved power efficiency and improved utilization of communication resources. For example, by implementing the DMRS sequence generation techniques described herein, devices may be able to transmit with increased power, while limiting negative impacts of increased power such as interference and noise.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of sequence generation for small resource block allocations of physical uplink shared channel transmissions as described herein, or the processor 1235 and the memory 1225 may be otherwise configured to perform or support such operations.

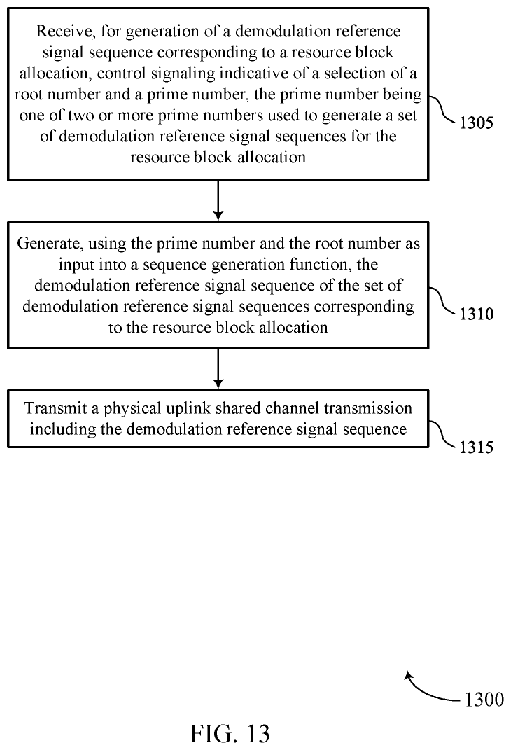

FIG. 13 illustrates a flowchart showing a method 1300 that supports sequence generation for small resource block allocations of physical uplink shared channel transmissions in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation. The operations of 1305 may be performed in accordance with examples as disclosed herein. In some examples, aspects of the operations of 1305 may be performed by a control signaling interface 725 as described with reference to FIG. 7.

At 1310, the method may include generating, using the prime number and the root number as input into a sequence generation function, the demodulation reference signal sequence of the set of demodulation reference signal sequences corresponding to the resource block allocation. The operations of 1310 may be performed in accordance with examples as disclosed herein. In some examples, aspects of the operations of 1310 may be performed by a sequence generation component 730 as described with reference to FIG. 7.

At 1315, the method may include transmitting a physical uplink shared channel transmission including the demodulation reference signal sequence. The operations of 1315 may be performed in accordance with examples as disclosed herein. In some examples, aspects of the operations of 1315 may be performed by an PUSCH interface 735 as described with reference to FIG. 7.

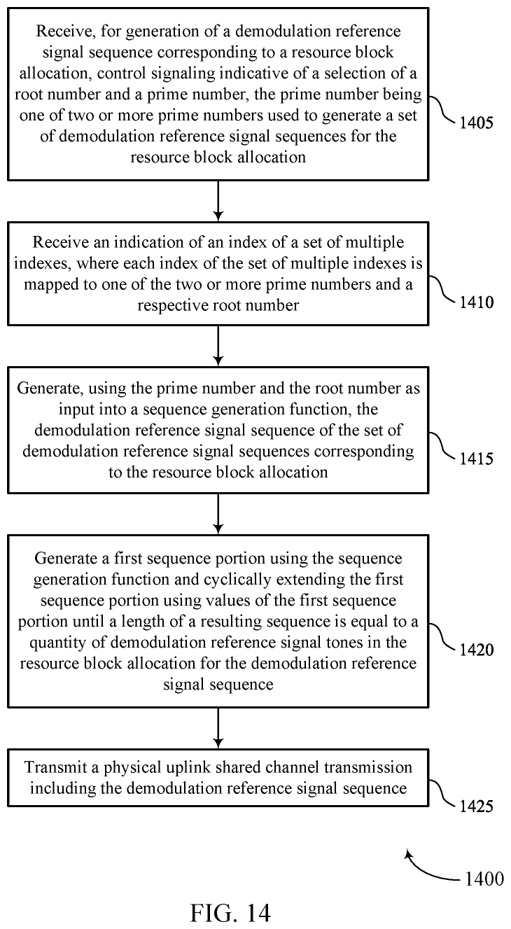

FIG. 14 illustrates a flowchart showing a method 1400 that supports sequence generation for small resource block allocations of physical uplink shared channel transmissions in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation. The operations of 1405 may be performed in accordance with examples as disclosed herein. In some examples, aspects of the operations of 1405 may be performed by a control signaling interface 725 as described with reference to FIG. 7.

At 1410, the method may include receiving an indication of an index of a set of multiple indexes, where each index of the set of multiple indexes is mapped to one of the two or more prime numbers and a respective root number. The operations of 1410 may be performed in accordance with examples as disclosed herein. In some examples, aspects of the operations of 1410 may be performed by an index interface 740 as described with reference to FIG. 7.

At 1415, the method may include generating, using the prime number and the root number as input into a sequence generation function, the demodulation reference signal sequence of the set of demodulation reference signal sequences corresponding to the resource block allocation. The operations of 1415 may be performed in accordance with examples as disclosed herein. In some examples, aspects of the operations of 1415 may be performed by a sequence generation component 730 as described with reference to FIG. 7.

At 1420, the method may include generating a first sequence portion using the sequence generation function and cyclically extending the first sequence portion using values of the first sequence portion until a length of a resulting sequence is equal to a quantity of demodulation reference signal tones in the resource block allocation for the demodulation reference signal sequence. The operations of 1420 may be performed in accordance with examples as disclosed herein. In some examples, aspects of the operations of 1420 may be performed by a cyclic extension component 750 as described with reference to FIG. 7.

At 1425, the method may include transmitting a physical uplink shared channel transmission including the demodulation reference signal sequence. The operations of 1425 may be performed in accordance with examples as disclosed herein. In some examples, aspects of the operations of 1425 may be performed by an PUSCH interface 735 as described with reference to FIG. 7.

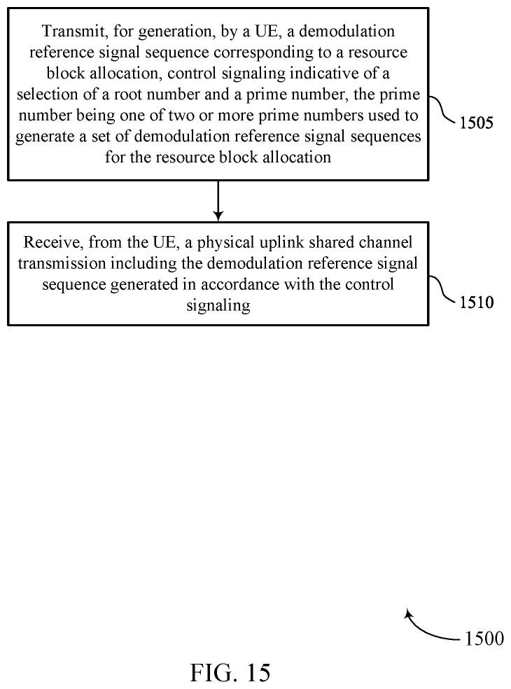

FIG. 15 illustrates a flowchart showing a method 1500 that supports sequence generation for small resource block allocations of physical uplink shared channel transmissions in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation. The operations of 1505 may be performed in accordance with examples as disclosed herein. In some examples, aspects of the operations of 1505 may be performed by a control signaling interface 1125 as described with reference to FIG. 11.

At 1510, the method may include receiving, from the UE, a physical uplink shared channel transmission including the demodulation reference signal sequence generated in accordance with the control signaling. The operations of 1510 may be performed in accordance with examples as disclosed herein. In some examples, aspects of the operations of 1510 may be performed by an PUSCH interface 1130 as described with reference to FIG. 11.

The following provides an overview of aspects of the present disclosure:

Aspect 1: A method for wireless communications at a UE, comprising: receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation; generating, using the prime number and the root number as input into a sequence generation function, the demodulation reference signal sequence of the set of demodulation reference signal sequences corresponding to the resource block allocation; and transmitting a physical uplink shared channel transmission including the demodulation reference signal sequence.

Aspect 2: The method of aspect 1, wherein the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

Aspect 3: The method of any of aspects 1 through 2, wherein receiving the control signaling comprises: receiving an indication of an index of a plurality of indexes, wherein each index of the plurality of indexes is mapped to one of the two or more prime numbers and a respective root number.

Aspect 4: The method of any of aspects 1 through 3, wherein the two or more prime numbers for the resource block allocation are selected in accordance with a selection rule for selecting the two or more prime numbers based at least in part on a proximity of the two or more prime numbers to a quantity of demodulation reference signal tones for the resource block allocation.

Aspect 5: The method of aspect 4, wherein the selection rule indicates a threshold proximity to the quantity of demodulation reference signals.

Aspect 6: The method of any of aspects 1 through 5, wherein the set of demodulation reference signal sequences is generated using a subset of root numbers for a first prime number of the two or more prime numbers.

Aspect 7: The method of aspect 6, wherein the subset of root numbers is selected to exclude root numbers that result in high cross-correlated sequences from the set of demodulation reference signal sequences.

Aspect 8: The method of any of aspects 1 through 7, wherein the set of demodulation reference signal sequences are enumerated using a prime number of the two or more prime numbers and a respective root number; and the root number and the prime number indicated via the control signaling correspond to the demodulation reference signal sequence of the set of enumerated demodulated reference signal sequences.

Aspect 9: The method of any of aspects 1 through 8, wherein generating the demodulation reference signal sequence comprises: generating a first sequence portion using the sequence generation function and cyclically extending the first sequence portion using values of the first sequence portion until a length of a resulting sequence is equal to a quantity of demodulation reference signal tones in the resource block allocation for the demodulation reference signal sequence.

Aspect 10: The method of aspect 9, wherein the first sequence portion is cyclically extended based at least in part on the resource block allocation being subject to a quantity of excess resource blocks due to bandwidth expansion.

Aspect 11: The method of any of aspects 1 through 10, wherein generating a subset of demodulation reference signal sequences using one of the two or more prime numbers results in a quantity of sequences that is less than a threshold quantity of sequences associated with limiting inter-cell interference.

Aspect 12: The method of any of aspects 1 through 11, wherein the two or more prime numbers are used to generate the set of demodulation reference signal sequences irrespective of a rule for selecting a single prime number that is less than a sequence length associated with the resource block allocation.

Aspect 13: The method of any of aspects 1 through 12, wherein generating the demodulation reference signal sequence comprises: generating, using a Zadoff-Chu function as the sequence generation function, the demodulation reference signal sequence.

Aspect 14: A method for wireless communications at a network entity, comprising: transmitting, for generation, by a UE, a demodulation reference signal sequence corresponding to a resource block allocation, control signaling indicative of a selection of a root number and a prime number, the prime number being one of two or more prime numbers used to generate a set of demodulation reference signal sequences for the resource block allocation; and receiving, from the UE, a physical uplink shared channel transmission including the demodulation reference signal sequence generated in accordance with the control signaling.

Aspect 15: The method of aspect 14, wherein the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

Aspect 16: The method of any of aspects 14 through 15, wherein transmitting the control signaling comprises: transmitting an indication of an index that is mapped to the root number and the prime number, the index being one of a plurality of indexes and each index of the plurality of indexes being mapped to one of the two or more prime numbers and a respective root number.

Aspect 17: The method of any of aspects 14 through 16, wherein the two or more prime numbers for the resource block allocation are selected in accordance with a selection rule for selecting the two or more prime numbers based at least in part on a proximity of the two or more prime numbers to a quantity of demodulation reference signal tones for the resource block allocation.

Aspect 18: The method of aspect 17, wherein the selection rule indicates a threshold proximity to the quantity of demodulation reference signals.

Aspect 19: The method of any of aspects 14 through 18, wherein the set of demodulation reference signal sequences is generated using a subset of root numbers for a first prime number of the two or more prime numbers.

Aspect 20: The method of aspect 19, wherein the subset of root numbers is selected to exclude root numbers that result in high cross-correlated sequences from the set of demodulation reference signal sequences.

Aspect 21: The method of any of aspects 14 through 20, wherein the set of demodulation reference signal sequences are enumerated using a prime number of the two or more prime numbers and a respective root number, the root number and the prime number indicated via the control signaling correspond to the demodulation reference signal sequence of the set of enumerated demodulated reference signal sequences.

Aspect 22: The method of any of aspects 14 through 21, wherein generating a subset of demodulation reference signal sequences using one of the two or more prime numbers results in a quantity of sequences that is less than a threshold quantity of sequences associated with limiting inter-cell interference.

Aspect 23: The method of any of aspects 14 through 22, wherein the two or more prime numbers are used to generate the set of demodulation reference signal sequences irrespective of a rule for selecting a single prime number that is less than a sequence length associated with the resource block allocation.

Aspect 24: The method of any of aspects 14 through 23, wherein each demodulation reference signal sequence of the set of demodulation reference signal sequences is generated using a Zadoff-Chu function.

Aspect 25: A UE, comprising one or more memories storing processor-executable code; one or more processors coupled with the one or more memories and individually or collectively operable to execute the code to cause the UE to perform a method of any of aspects 1 through 13.

Aspect 26: An apparatus for wireless communications at a UE, comprising at least one means for performing a method of any of aspects 1 through 13.

Aspect 27: A non-transitory computer-readable medium storing code for wireless communications at a UE, the code comprising instructions executable by a processor to perform a method of any of aspects 1 through 13.

Aspect 28: A network entity, comprising one or more processors coupled with the one or more memories and individually or collectively operable to execute the code to cause the network entity to perform a method of any of aspects 14 through 24.

Aspect 29: An apparatus for wireless communications at a network entity, comprising at least one means for performing a method of any of aspects 14 through 24.

Aspect 30: A non-transitory computer-readable medium storing code for wireless communications at a network entity, the code comprising instructions executable by a processor to perform a method of any of aspects 14 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation;
generate, using the prime number and the root number as input into a sequence generation function, the demodulation reference signal sequence of the set of demodulation reference signal sequences corresponding to the resource block allocation; and
transmit a physical uplink shared channel transmission including the demodulation reference signal sequence.

2. The UE of claim 1, wherein the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

3. The UE of claim 1, wherein, to receive the control signaling, the one or more processors are individually or collectively further operable to execute the code to cause UE to:
receive an indication of an index of a plurality of indexes, wherein each index of the plurality of indexes is mapped to one of the two or more prime numbers and a respective root number.

4. The UE of claim 1, wherein the two or more prime numbers for the resource block allocation are selected in accordance with a selection rule for selecting the two or more prime numbers based at least in part on a proximity of the two or more prime numbers to a quantity of demodulation reference signal tones for the resource block allocation.

5. The UE of claim 4, wherein the selection rule indicates a threshold proximity to the quantity of demodulation reference signals.

6. The UE of claim 1, wherein the set of demodulation reference signal sequences is generated using a subset of root numbers for a first prime number of the two or more prime numbers.

7. The UE of claim 6, wherein the subset of root numbers is selected to exclude root numbers that result in high cross-correlated sequences from the set of demodulation reference signal sequences.

8. The UE of claim 1, wherein:
the set of demodulation reference signal sequences are enumerated using a prime number of the two or more prime numbers and a respective root number; and
the root number and the prime number indicated via the control signaling correspond to the demodulation reference signal sequence of the set of enumerated demodulated reference signal sequences.

9. The UE of claim 1, wherein, to generate the demodulation reference signal sequence, the one or more processors are individually or collectively further operable to execute the code to cause UE to:
generate a first sequence portion using the sequence generation function and cyclically extending the first sequence portion using values of the first sequence portion until a length of a resulting sequence is equal to a quantity of demodulation reference signal tones in the resource block allocation for the demodulation reference signal sequence.

10. The UE of claim 9, wherein the first sequence portion is cyclically extended based at least in part on the resource block allocation being subject to a quantity of excess resource blocks due to bandwidth expansion.

11. The UE of claim 1, wherein generating a subset of demodulation reference signal sequences using one of the two or more prime numbers results in a quantity of sequences that is less than a threshold quantity of sequences associated with limiting inter-cell interference.

12. The UE of claim 1, wherein the two or more prime numbers are used to generate the set of demodulation reference signal sequences irrespective of a rule for selecting a single prime number that is less than a sequence length associated with the resource block allocation.

13. The UE of claim 1, wherein, to generate the demodulation reference signal sequence, the one or more processors are individually or collectively further operable to execute the code to cause the UE to:
generate, using a Zadoff-Chu function as the sequence generation function, the demodulation reference signal sequence.

14. A network entity, comprising:
one or more memories storing processor-executable code; and
one or more processors coupled with the one or more memories and individually or collectively operable to execute the code to cause the network entity to:
transmit, for generation, by a user equipment (UE), a demodulation reference signal sequence corresponding to a resource block allocation, control signaling indicative of a selection of a root number and a prime number, the prime number being one of two or more prime numbers used to generate a set of demodulation reference signal sequences for the resource block allocation; and
receive, from the UE, a physical uplink shared channel transmission including the demodulation reference signal sequence generated in accordance with the control signaling.

15. The network entity of claim 14, wherein the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

16. The network entity of claim 14, wherein, to transmit the control signaling, the one or more processors are individually or collectively further operable to execute the code to cause the network entity to:
transmit an indication of an index that is mapped to the root number and the prime number, the index being one of a plurality of indexes and each index of the plurality of indexes being mapped to one of the two or more prime numbers and a respective root number.

17. The network entity of claim 14, wherein the two or more prime numbers for the resource block allocation are selected in accordance with a selection rule for selecting the two or more prime numbers based at least in part on a proximity of the two or more prime numbers to a quantity of demodulation reference signal tones for the resource block allocation.

18. The network entity of claim 17, wherein the selection rule indicates a threshold proximity to the quantity of demodulation reference signals.

19. The network entity of claim 14, wherein the set of demodulation reference signal sequences is generated using a subset of root numbers for a first prime number of the two or more prime numbers.

20. The network entity of claim 19, wherein the subset of root numbers is selected to exclude root numbers that result in high cross-correlated sequences from the set of demodulation reference signal sequences.

21. The network entity of claim 14, wherein:
the set of demodulation reference signal sequences are enumerated using a prime number of the two or more prime numbers and a respective root number,
the root number and the prime number indicated via the control signaling correspond to the demodulation reference signal sequence of the set of enumerated demodulated reference signal sequences.

22. The network entity of claim 14, wherein generating a subset of demodulation reference signal sequences using one of the two or more prime numbers results in a quantity of sequences that is less than a threshold quantity of sequences associated with limiting inter-cell interference.

23. The network entity of claim 14, wherein the two or more prime numbers are used to generate the set of demodulation reference signal sequences irrespective of a rule for selecting a single prime number that is less than a sequence length associated with the resource block allocation.

24. The network entity of claim 14, wherein each demodulation reference signal sequence of the set of demodulation reference signal sequences is generated using a Zadoff-Chu function.

25. A method for wireless communications at a user equipment (UE), comprising:
receiving, for generation of a demodulation reference signal sequence corresponding to a resource block allocation, control signaling indicative of a selection of a root number and a prime number, the prime number being one of two or more prime numbers used to generate a set of demodulation reference signal sequences for the resource block allocation;
generating, using the prime number and the root number as input into a sequence generation function, the demodulation reference signal sequence of the set of demodulation reference signal sequences corresponding to the resource block allocation; and
transmitting a physical uplink shared channel transmission including the demodulation reference signal sequence.

26. The method of claim 25, wherein the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

27. The method of claim 25, wherein receiving the control signaling comprises:
receiving an indication of an index of a plurality of indexes, wherein each index of the plurality of indexes is mapped to one of the two or more prime numbers and a respective root number.

28. A method for wireless communications at a network entity, comprising:
transmitting, for generation, by a user equipment (UE), a demodulation reference signal sequence corresponding to a resource block allocation, control signaling indicative of a selection of a root number and a prime number, the prime number being one of two or more prime numbers used to generate a set of demodulation reference signal sequences for the resource block allocation; and
receiving, from the UE, a physical uplink shared channel transmission including the demodulation reference signal sequence generated in accordance with the control signaling.

29. The method of claim 28, wherein the set of demodulation reference signal sequences for the resource block allocation includes a first subset of sequences having a first length and generated using a first prime number of the two or more prime numbers and a second subset of sequences having a second length and generated using a second prime numbers of the two or more prime numbers.

30. The method of claim 28, wherein transmitting the control signaling comprises:
transmitting an indication of an index that is mapped to the root number and the prime number, the index being one of a plurality of indexes and each index of the plurality of indexes being mapped to one of the two or more prime numbers and a respective root number.
